(19) United States
(12) Patent Application Publication
(10) Pub. No.: US 2026/0162893 A1
(43) Pub. Date: Jun. 11, 2026

(54) MULTILAYER ELECTRONIC COMPONENT

(71) Applicant: SAMSUNG ELECTRO-MECHANICS CO., LTD., Suwon-si (KR)

(72) Inventors: Hwa Pyeong YANG, Suwon-si (KR); Hyuk Jin HONG, Suwon-si (KR); Dong Ju KIM, Suwon-si (KR)

(73) Assignee: SAMSUNG ELECTRO-MECHANICS CO., LTD., Suwon-si (KR)

(21) Appl. No.: 19/386,426

(22) Filed: Nov. 12, 2025

(30) Foreign Application Priority Data
Dec. 6, 2024 (KR) 10-2024-0180274
Mar. 26, 2025 (KR) 10-2025-0038835

(51) Int. Cl. H01G 4/005; H01G 4/30

(52) U.S. Cl. CPC H01G 4/005; H01G 4/30

(57) ABSTRACT

A multilayer electronic component includes a body including a dielectric layer and an internal electrode alternately disposed with the dielectric layer in a thickness direction, the body having first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and an external electrode disposed on the third and fourth surfaces, wherein the internal electrode is disposed to be spaced apart from the fifth and sixth surfaces with a margin portion interposed therebetween, wherein a first dummy electrode including a dielectric receiving portion is disposed in the margin portion.

### CROSS-REFERENCE TO RELATED APPLICATION(S)

This application claims the benefit of priority to Korean Patent Application Nos. 10-2024-0180274 filed on Dec. 6, 2024 and 10-2025-0038835 filed on Mar. 26, 2025, in the Korean Intellectual Property Office, the disclosures of which are incorporated herein by reference in its entirety.

### TECHNICAL FIELD

The present disclosure relates to a multilayer electronic component.

### BACKGROUND

A multilayer ceramic capacitor (MLCC), a multilayer electronic component, may be a chip-type condenser mounted on the printed circuit boards of any of various electronic products, such as an image display device including a liquid crystal display (LCD) or a plasma display panel (PDP), a computer, a smartphone, or a mobile phone, to charge or discharge electricity therein or therefrom. The multilayer ceramic capacitor (MLCC) has a small size, implements high capacitance, and is easily mounted, and may thus be used as a component of various electronic devices.

A body of the MLCC may include a capacitance formation portion in which internal electrodes overlap to form capacitance and a margin portion, other than the capacitance formation portion. Meanwhile, a step difference may occur between the capacitance formation portion and the margin portion during a compressing and sintering process due to a difference in the number of stacked layers of the internal electrodes. Such a step difference may cause ends of the internal electrodes to bend or stretch, which may deteriorate withstand voltage characteristics and structural stability of the MLCC.

### SUMMARY

An aspect of the present disclosure may improve withstand voltage characteristics and structural stability of a multilayer electronic component by alleviating a step difference between a capacitance formation portion and a margin portion.

However, the present disclosure is not limited to the description above, and may be more readily understood in the description of exemplary embodiments of the present disclosure.

According to an aspect of the present disclosure, a multilayer electronic component may include a body including a dielectric layer and an internal electrode alternately disposed with the dielectric layer in a thickness direction, the body having first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and an external electrode disposed on the third and fourth surfaces, wherein the internal electrode may be disposed to be spaced apart from the fifth and sixth surfaces with a margin portion interposed therebetween, wherein a first dummy electrode including a dielectric receiving portion may be disposed in the margin portion.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a multilayer electronic component according to an embodiment of the present disclosure;

FIG. 2 is a cross-sectional view schematically illustrating a cross-section of FIG. 1, taken along line I-I′;

FIG. 3 is a cross-sectional view schematically illustrating a cross-section of FIG. 1, taken along line II-II′;

FIG. 4A is a plan view schematically illustrating a first internal electrode and a first dummy electrode of the multilayer electronic component of FIG. 1;

FIG. 4B is a plan view schematically illustrating a second internal electrode and a first dummy electrode of the multilayer electronic component of FIG. 1;

FIG. 5 is a cross-sectional view schematically illustrating a cross-section of FIG. 4A, taken along line III-III′;

FIG. 6 is a partially enlarged view of FIG. 4A;

FIG. 7A is a plan view schematically illustrating a first internal electrode, a first dummy electrode, and a second dummy electrode of a multilayer electronic component according to another embodiment of the present disclosure;

FIG. 7B is a plan view schematically illustrating a second internal electrode, a first dummy electrode, and a second dummy electrode of a multilayer electronic component according to another embodiment of the present disclosure;

FIG. 8 is a cross-sectional view schematically illustrating a cross-section of FIG. 7A, taken along line IV-IV′;

FIG. 9 is a partially enlarged view of FIG. 7A; FIG. 10 is a schematic partially enlarged view of region A of FIG. 8;

FIG. 11 is a modified example of FIG. 10;

FIG. 12A is a plan view schematically illustrating a first internal electrode, a first dummy electrode, and a second dummy electrode of a multilayer electronic component according to another embodiment of the present disclosure;

FIG. 12B is a plan view schematically illustrating a second internal electrode, a first dummy electrode, and a second dummy electrode of a multilayer electronic component according to another embodiment of the present disclosure;

FIG. 13 is a cross-sectional view schematically illustrating a cross-section of FIG. 12A, taken along line V-V′; and

FIG. 14 is a partially enlarged view of FIG. 12A.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clarity of description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, an X direction may be defined as a thickness (T) direction, a Y direction may be defined as a length (L) direction, and a Z direction may be defined as a width (W) direction. In the present disclosure, “thickness” may refer to a size in the thickness direction, “length” may refer to a size in the length direction, and “width” may refer to a size in the width direction.

### Multilayer Electronic Component

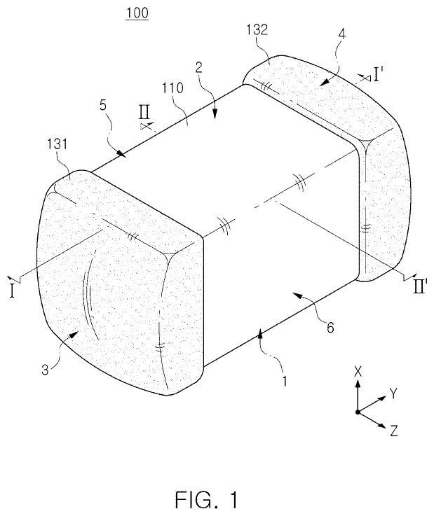

FIG. 1 is a perspective view schematically illustrating a multilayer electronic component according to an embodiment of the present disclosure.

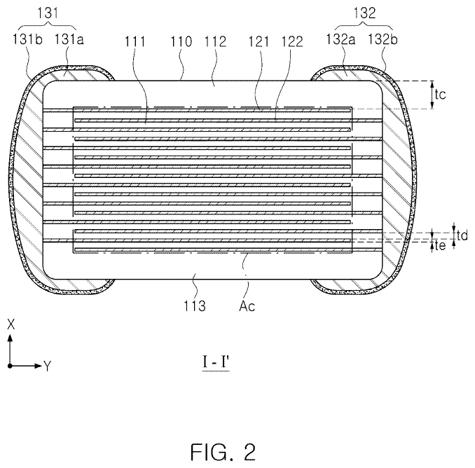

FIG. 2 is a cross-sectional view schematically illustrating a cross-section of FIG. 1, taken along line I-I′.

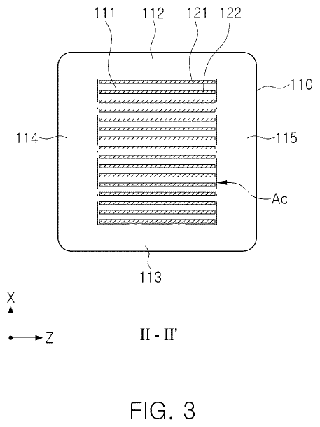

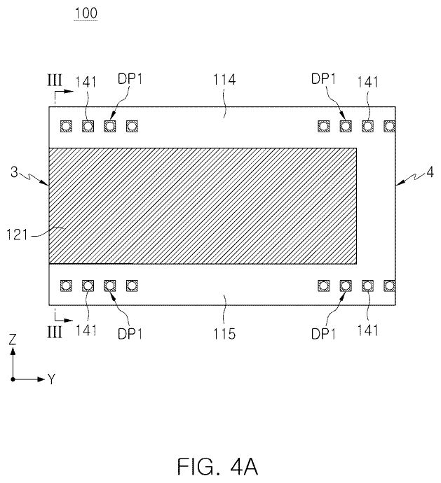

FIG. 3 is a cross-sectional view schematically illustrating a cross-section of FIG. 1, taken along line II-II′.

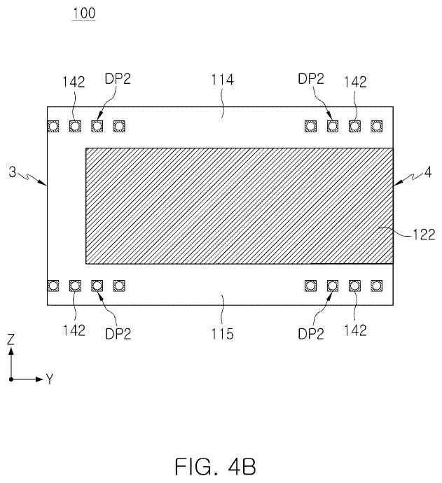

FIG. 4A is a plan view schematically illustrating a first internal electrode and a first dummy electrode of the multilayer electronic component of FIG. 1.

FIG. 4B is a plan view schematically illustrating a second internal electrode and a first dummy electrode of the multilayer electronic component of FIG. 1.

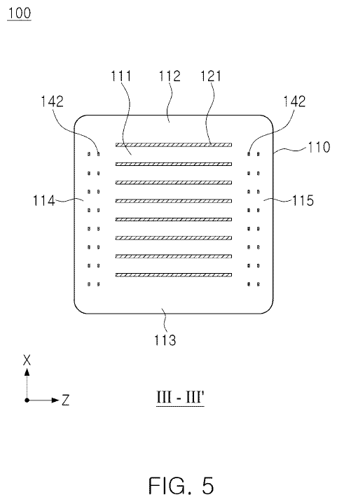

FIG. 5 is a cross-sectional view schematically illustrating a cross-section of FIG. 4A, taken along line III-III′.

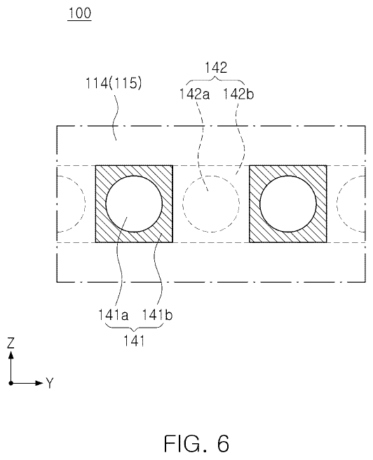

FIG. 6 is a partially enlarged view of FIG. 4A.

Hereinafter, a multilayer electronic component 100 according to an embodiment of the present disclosure will be described in greater detail with reference to FIGS. 1 to 6. In addition, a multilayer ceramic capacitor will be described as an example of a multilayer electronic component, but the present disclosure is not limited thereto, and it may also be applied to various multilayer electronic components such as an inductor and piezoelectric elements, varistors, thermistors, or the like.

A length of the multilayer electronic component 100 may be greater than a width and a thickness of the multilayer electronic component 100, respectively, but the present disclosure is not limited thereto. For example, the length of the multilayer electronic component 100 may be smaller than the width of the multilayer electronic component 100. The width of the multilayer electronic component 100 may be smaller or larger than the thickness of the multilayer electronic component 100, which may vary depending on the target specifications and characteristics of the multilayer electronic component 100.

The length of the multilayer electronic component 100 may be, for example, about 0.1 mm to 5.7 mm, the width of the multilayer electronic component 100 may be, for example, about 0.05 mm to 5.0 mm, and the thickness of the multilayer electronic component 100 may be, for example, about 0.05 mm to 5.0 mm.

The multilayer electronic component 100 according to an embodiment of the present disclosure may include a body 110 and external electrodes 131 and 132.

Although the detailed shape of the body 110 is not particularly limited, as illustrated, the body 110 may have a hexahedral shape or a shape similar thereto. Due to shrinkage of ceramic powder included in the body 110 during a sintering process or polishing of corners of the body 110, the body 110 may not have a hexahedral shape with perfect straight lines, but may substantially have a hexahedral shape.

The body 110 may include first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

The body 110 may include a dielectric layer 111 and internal electrodes 121 and 122 alternately disposed with the dielectric layer 111 in the thickness direction. A plurality of dielectric layers 111 forming the body 110 may be in a sintered state, and a boundary between adjacent dielectric layers 111 may be integrated to the extent that it is difficult to confirm without a scanning electron microscope (SEM).

The dielectric layer 111 may include, for example, a perovskite-type compound represented by ABO₃ as a main component. The perovskite-type compound represented by ABO₃ may include, for example, at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ) (Zr_{1-y}Ti_{y})O₃ (0<x≤0.5, 0<y≤0.5).

An average thickness “td” of the dielectric layer 111 is not particularly limited. The average thickness “td” of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

The body 110 may include a capacitance formation portion Ac including a first internal electrode 121 and a second internal electrode 122 alternately disposed with the dielectric layer 111 interposed therebetween, to form capacitance. A stacking direction of the internal electrodes 121 and 122 may be a thickness direction or a width direction. In the present disclosure, it is described based on an embodiment in which the stacking direction of the internal electrodes 121 and 122 is the thickness direction.

The first internal electrode 121 may be spaced apart from the fourth surface 4 and may be connected to a first external electrode 131 on the third surface 3. The second internal electrode 122 may be spaced apart from the third surface 3 and may be connected to a second external electrode 132 on the third surface 4.

A conductive metal included in the internal electrodes 121 and 122 may be at least one of Ni, Cu, Pd, Ag, Au, Pt, Sn, W, Ti, and alloys thereof, and more preferably may include Ni, but the present disclosure is not limited thereto.

An average thickness “te” of the internal electrodes 121 and 122 is not particularly limited. The average thickness “te” of the internal electrodes 121 and 122 may be, for example, 0.1 μm to 3.0 μm, 0.1 μm to 1.0 μm, or 0.1 μm to 0.4 μm.

The average thickness “td” of the dielectric layer 111 and the average thickness “te” of the internal electrodes 121 and 122 may be measured by scanning a cross-section of the multilayer electronic component 100 in the length and thickness directions with a scanning electron microscope (SEM) at a magnification of 10,000. More specifically, the average thickness “td” of the dielectric layer 111 may be measured by measuring a thickness of one dielectric layer 111 at a plurality of points thereof, for example, at 5 points equally spaced in the length direction, and then measuring the average value. In addition, the average thickness “te” of the internal electrodes 121 and 122 may be measured by measuring a thickness of one internal electrode (121, 122) at a plurality of points thereof, for example, at 5 points equally spaced in the length direction, and then measuring the average value. The 5 equally spaced points may be designated in the capacitance formation portion Ac. Meanwhile, when such measurement of the average values for each of the 10 dielectric layers 111 and 10 internal electrodes 121 and 122, the average thickness “td” of the dielectric layer 111 and the average thickness “te” of the internal electrodes 121 and 122 may be further generalized.

The body 110 may include cover portions 112 and 113 disposed on both surfaces of the capacitance formation portion Ac opposing each other in the thickness direction and margin portions 114 and 115 disposed on both surfaces of the capacitance formation portion Ac opposing each other in the width direction. The cover portions 112 and 113 and the margin portions 114 and 115 may have a configuration similar to the dielectric layer 111 except for not including an internal electrode. The internal electrodes 121 and 122 may be disposed to be spaced apart from the fifth and sixth surfaces 5 and 6 with the margin portions 114 and 115 interposed therebetween. A first margin portion 114 may be disposed between the internal electrodes 121 and 122 and the fifth surface 5, and a second margin portion 115 may be disposed between the internal electrodes 121 and 122 and the sixth surface 6.

An average thickness “tc” of the cover portions 112 and 113 may be, for example, 150 μm or less, 100 μm or less, 30 μm or less, or 20 μm or less. The average thickness “tc” of the cover portions 112 and 113 may be, for example, 5 μm or more or 10 μm or more. The average thickness “tc” of the cover portions 112 and 113 refers to an average thickness of each of the first cover portion 112 and the second cover portion 113. The average thickness “tc” of the cover portions 112 and 113 may be a value obtained by averaging thicknesses measured at 5 equally spaced points in the length direction in the cross-section of the multilayer electronic component 100 in the length direction and the thickness direction.

An average width of the margin portions 114 and 115 is not particularly limited. The average width of the margin portions 114 and 115 may be, for example, 150 μm or less, 100 μm or less, 20 μm or less, or 15 μm or less. The average width of the margin portions 114 and 115 refers to an average width of each of the first margin portion 114 and the second margin portion 115. The average width of the margin portions 114 and 115 may be a value by averaging widths measured at 5 equally spaced points in the thickness direction in the cross-section of the multilayer electronic component 100 in the width direction and the thickness direction.

External electrodes 131 and 132 may be disposed on the third and fourth surfaces 3 and 4. A first external electrode 131 may be disposed on the third surface 3, and may extend onto portions of the first, second, fifth, and sixth surfaces 1, 2, 5, and 6. A second external electrode 132 may be disposed on the fourth surface 4, and may extend onto portions of the first, second, fifth, and sixth surfaces 1, 2, 5, and 6.

A type or shape of the external electrodes 131 and 132 is not particularly limited, and may have a multilayer structure. For example, the external electrodes 131 and 132 may include base electrodes layer 131a and 132a in contact with the internal electrodes 121 and 122 and plating layers 131b and 132b disposed on the base electrode layers 131a and 132a.

The base electrode layers 131a and 132a may include a sintered electrode layer including a metal and glass. The metal included in the sintered electrode layer may include, for example, Cu, Ni, Pd, Pt, Au, Ag, Pb and/or an alloy including the same. The glass included in the sintered electrode layer may include, for example, one or more oxides of Ba, Ca, Zn, Al, B and Si.

Meanwhile, the base electrode layers 131a and 132a may be comprised of only a sintered electrode layer, but the present disclosure is not limited thereto, and the base electrode layers 131a and 132a may include a sintered electrode layer including metal and glass, and a resin electrode layer disposed on the sintered electrode layer and including metal particles and a resin.

The metal particles included in the resin electrode layer may include at least one of spherical particles and flake-shaped particles. The metal particles included in the resin electrode layer may include, for example, Cu, Ni, Pd, Pt, Au, Ag, Pb, Sn and/or an alloy including the same. The resin included in the resin electrode layer may include, for example, at least one of an epoxy resin, acrylic resin, and ethyl cellulose.

The plating layers 131b and 132b may include, for example, Ni, Sn, Pd, and/or an alloy including the same, and may be formed of a plurality of layers. The plating layers 131b and 132b may be, for example, an Ni plating layer or a Sn plating layer, and may be in a form in which an Ni plating layer and a Sn plating layer are sequentially formed. The plating layers 131b and 132b may include a plurality of Ni plating layers and/or a plurality of Sn plating layers.

In the drawings, a structure in which the multilayer electronic component 100 has two external electrodes 131 and 132 is described, but the present disclosure is not limited thereto, and the number and shape of the external electrodes 131 and 132 may be changed according to the shape of the internal electrodes 121 and 122 or other purposes.

There is a difference in the number of stacked internal electrodes between a capacitance formation portion in which the first and second internal electrodes overlap and a margin portion in which the internal electrodes are not disposed. Accordingly, a step difference may occur between the capacitance formation portion and the margin portion during a compressing and sintering process. There is a concern that an end of the internal electrode in the width direction may be bent or stretched due to such a step difference, which may deteriorate withstand voltage characteristics and structural stability of the multilayer electronic component. Additionally, because the ceramic green sheets adhere to one another by means of the pressing operation, they may be susceptible to shear stress generated by an external force applied in the transverse direction.

On the other hand, a multilayer electronic component 100 according to an embodiment of the present disclosure may include first dummy electrodes 141 and 142 disposed in margin portions 114 and 115. The first dummy electrodes 141 and 142 may be disposed in the margin portions 114 and 115 in which the internal electrodes 121 and 122 are not disposed, thereby alleviating a step difference due to the difference in the number of stacked internal electrodes 121 and 122 between the capacitance formation portion Ac and the margin portions 114 and 115, thereby improving the withstand voltage characteristics and structural stability of the multilayer electronic component 100.

According to an embodiment of the present disclosure, the first dummy electrodes 141 and 142 may include dielectric receiving portions 141a and 142a. The dielectric receiving portions 141a and 142a may receive a dielectric of the margin portions 114 and 115. That is, the dielectric receiving portions 141a and 142a may include at least a portion of the margin portions 114 and 115. The first dummy electrodes 141 and 142 may physically fix a portion of the margin portions 114 and 115 disposed in the dielectric receiving portions 141a and 142a to improve the stability of the multilayer electronic component 100 against shear stress.

The dummy electrode and the dielectric receiving portion of the dummy electrode may function as a structural chain connecting the ceramic green sheets to one another, thereby distributing the shear stress across multiple layers and consequently reducing the shear stress applied to any single layer.

The shape of the first dummy electrodes 141 and 142 is not particularly limited, but the first dummy electrodes 141 and 142 may include dummy conductive portions 141b and 142b surrounding the dielectric receiving portions 141a and 142a in the length direction and the width direction. That is, the first dummy electrodes 141 and 142 may include ring-shaped dummy conductive portions 141b and 142b.

A cross-section of the first dummy electrodes 141 and 142 in the length direction and the width direction may be rectangular, but the present disclosure is not limited thereto. For example, the cross-section of the first dummy electrodes 141 and 142 in the length direction and the width direction may be circular or polygonal, and the first dummy electrodes 141 and 142 may have any shape as long as the first dummy electrodes 141 and 142 can include dielectric receiving portions 141a and 142a.

A cross-section of the dielectric receiving portions 141a and 142a in the length direction and the width direction may be circular, but the present disclosure is not limited thereto. For example, the cross-section of the dielectric receiving portions 141a and 142a in the length direction and the width direction may be polygonal, and the dielectric receiving portions 141a and 142a may have any shape as long as the dielectric receiving portions 141a and 142a can receive a dielectric.

First dummy portions 141 and 142 may be disposed in a first margin portion and a second margin portion 115, respectively. The first dummy portions 141 and 142 may be disposed at both ends of the first and second margin portions 114 and 115 in the length direction, respectively, for example. The first dummy portions 141 and 142 may be disposed, for example, in a region of the first and second margin portions 114 and 115 adjacent to the third and fourth surfaces 3 and 4, respectively. A first internal electrode 121 and a second internal electrode 122 may be stacked in the capacitance formation portion Ac, but only the first internal electrode 121 or the second internal electrode 122 may be present on both sides (so-called L-margin) of the capacitance formation portion Ac of the body 110 in the length direction. Accordingly, a step difference may occur between the capacitance formation portion Ac and the L-margin due to a difference in the number of stacked internal electrodes 121 and 122.

When the first dummy electrodes 141 and 142 are respectively disposed at both ends of the first and second margin portions 114 and 115 in the length direction, a step difference between the capacitance formation portion Ac and the margin portions 114 and 115 as well as a step difference between the capacitance formation portion Ac and the L-margin may be alleviated, thereby more effectively improving the withstand voltage characteristics and structural stability of the multilayer electronic component 100.

In an embodiment, a plurality of first dummy electrodes 141 and 142 may be disposed in a thickness direction, and the plurality of first dummy electrodes 141 and 142 may be disposed to be misaligned with adjacent first dummy electrodes 141 and 142 in the thickness direction, in a direction perpendicular to the thickness direction. For example, the first dummy electrodes 141 and 142 may be disposed in plural in the thickness direction, and may be disposed not to overlap the adjacent first dummy electrodes 141 and 142 in the thickness direction, in the thickness direction. For example, the first dummy electrode 141 may be disposed to be misaligned with the first dummy electrode 142 in a direction perpendicular to the thickness direction, and the first dummy electrode 141 may be disposed not to overlap the first dummy electrode 142 in the thickness direction.

That is, among the plurality of first dummy electrodes 141 and 142, those adjacent to each other in the thickness direction may be disposed to be misaligned in a direction perpendicular to the thickness direction. Among the plurality of first dummy electrodes 141 and 142, those adjacent to each other in the thickness direction may be disposed so as not to overlap in the thickness direction.

When the first dummy electrodes 141 and 142 adjacent to each other in the thickness direction are disposed to be misaligned in a direction perpendicular to the thickness direction, more preferably, when the first dummy electrodes 141 and 142 adjacent to each other in the thickness direction do not overlap in the thickness direction, the step difference between the capacitance formation portion Ac and the margin portions 114 and 115 may be effectively alleviated, and the effect of improving stability against shear stress through the dielectric receiving portions 141a and 142a may also be further improved.

In an embodiment, the first dummy electrodes 141 and 142 are provided in plural, and the plurality of first dummy electrodes 141 and 142 may be disposed in a length direction and/or width direction. For example, the multilayer electronic component 100 may include dummy patterns DP1 and DP2 including a plurality of first dummy electrodes 141 and 142 disposed at both ends of the margin portions 114 and 115 in the length direction, and arranged in the length direction and/or width direction.

Referring to FIGS. 4A and 4B, the dummy patterns DP1 and DP2 have first dummy electrodes 141 and 142 arranged in a 4×1 (length direction×width direction) form, but the present disclosure is not limited thereto. The dummy patterns DP1 and DP2 may include a plurality of first dummy electrodes 141 and 142 arranged in various forms, such as 1×2, 2×1, 2×2, 3×1, 3×2 (length direction×width direction), etc.

The multilayer electronic component 100 may include a first dummy pattern DP1 and a second dummy pattern DP2 alternately disposed in a thickness direction, and the first dummy pattern DP1 and the second dummy pattern DP2 may be disposed to be misaligned in a direction perpendicular to the thickness direction. For example, the first dummy pattern DP1 and the second dummy pattern DP2 may be disposed so as not to overlap each other in the thickness direction. Thereby, the step difference between the capacitance formation portion Ac and the margin portions 114 and 115 may be effectively alleviated, and the stability against shear stress may be effectively improved.

FIGS. 4A and 4B illustrate a structure in which two dummy patterns DP1 and DP2 spaced apart from each other in the length direction are disposed in the first margin portion 114 and the second margin portion 115, respectively, but the present disclosure is not limited thereto. For example, three or more dummy patterns DP1 and DP2 spaced apart from each other in the length direction may be disposed in the first margin portion 114 and the second margin portion 115, respectively.

FIG. 6 illustrates a structure in which a gap between the plurality of first dummy electrodes 141 and 142 in the length direction is the same as a length of the first dummy electrodes 141 and 142, but the present disclosure is not limited thereto. The gap between the plurality of first dummy electrodes 141 and 142 in the length direction may be greater than the length of the first dummy electrodes 141 and 142.

A conductive metal included in the first dummy electrodes 141 and 142 may be at least one of Ni, Cu, Pd, Ag, Au, Pt, Sn, W, Ti, and alloys thereof, and more preferably may include Ni, but the present disclosure is not limited thereto. The conductive metal included in the first dummy electrodes 141 and 142 may be the same as or different from the conductive metal included in the internal electrodes 121 and 122.

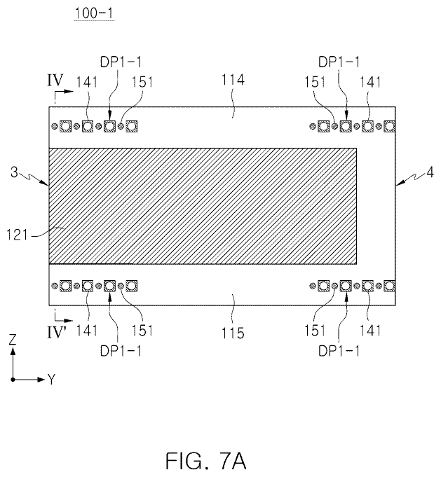

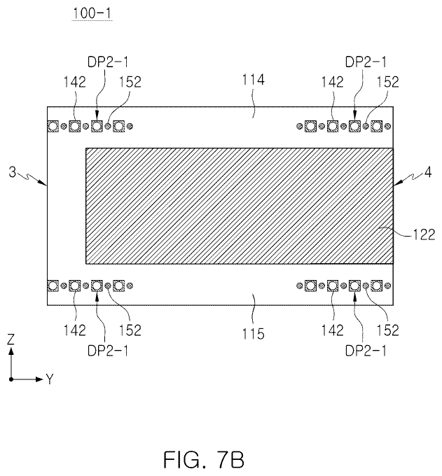

FIG. 7A is a plan view schematically illustrating a first internal electrode, a first dummy electrode, and a second dummy electrode of a multilayer electronic component according to another embodiment of the present disclosure.

FIG. 7B is a plan view schematically illustrating a second internal electrode, a first dummy electrode, and a second dummy electrode of a multilayer electronic component according to another embodiment of the present disclosure.

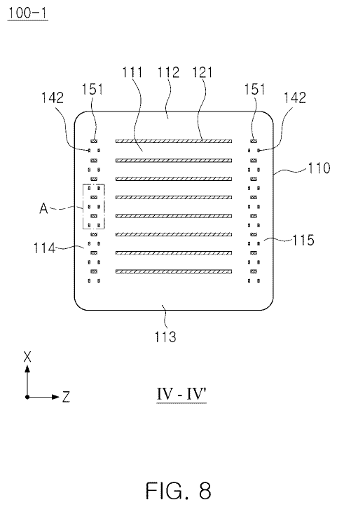

FIG. 8 is a cross-sectional view schematically illustrating a cross-section of FIG. 7A, taken along line IV-IV′.

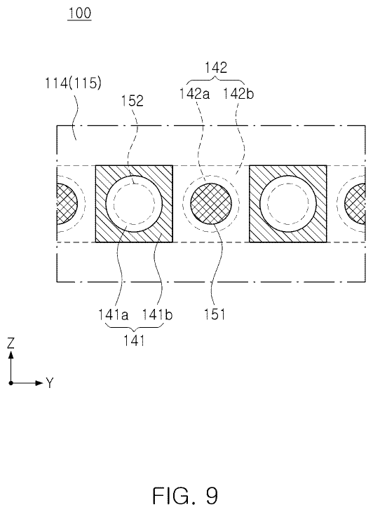

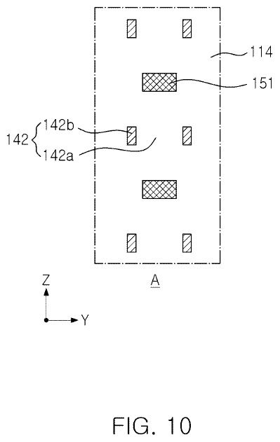

FIG. 9 is a partially enlarged view of FIG. 7A.

FIG. 10 is a schematic partially enlarged view of region A of FIG. 8.

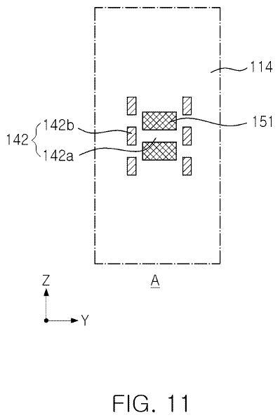

FIG. 11 is a modified example of FIG. 10.

Hereinafter, a multilayer electronic component 100-1 according to another embodiment of the present disclosure will be described with reference to FIGS. 7A to 11. For configurations identical/similar to those of the multilayer electronic component 100 described in FIGS. 1 to 6, identical/similar reference symbols are used, and duplicate descriptions thereof are omitted.

The multilayer electronic component 100-1 according to an embodiment of the present disclosure may include second dummy electrodes 151 and 152 disposed in margin portions 114 and 115 and overlapping the dielectric receiving portions 141a and 142a in a thickness direction. The multilayer electronic component 100-1 may effectively improve the withstand voltage characteristics and structural stability of the multilayer electronic component 100-1 by alleviating a step difference between the capacitance formation portion Ac and the margin portions 114 and 115 by including first dummy electrodes 141 and 142 and second dummy electrodes 151 and 152.

In an embodiment, the first dummy electrodes 141 and 142 and the second dummy electrodes 151 and 152 may be disposed in plural, respectively, and at least a portion of the plurality of first dummy electrodes 141 and 142 may be alternately disposed with at least a portion of the plurality of second dummy electrodes 151 and 152 in a thickness direction. That is, the first dummy electrode 141 and the second dummy electrode 152 may be alternately disposed in the thickness direction, and the first dummy electrode 142 and the second dummy electrode 151 may be alternately disposed in the thickness direction.

In an embodiment, the first dummy electrodes 141 and 142 and the second dummy electrodes 151 and 152 may be disposed in plural, respectively, and a portion of the plurality of first dummy electrodes 141 and 142 may be alternately disposed with a portion of the plurality of second dummy electrodes 151 and 152 in a length direction. For example, the first dummy electrode 141 and the second dummy electrode 151 may be alternately disposed in the length direction, and the first dummy electrode 142 and the second dummy electrode 152 may be alternately disposed in the length direction.

The multilayer electronic component 100-1 may include dummy patterns DP1-1 and DP2-1 including a plurality of first dummy electrodes 141 and 142 and second dummy electrodes 141 and 142 disposed at both ends of the margin portions 114 and 115 in a length direction, and arranged in the length direction.

The multilayer electronic component 100-1 may include a first dummy pattern DP1-1 and a second dummy pattern DP2-1 alternately disposed in a thickness direction, and the first dummy electrode 141 of the first dummy pattern DP1-1 may overlap the second dummy electrode 152 of the second dummy pattern DP2-1 in the thickness direction, and the second dummy electrode 151 of the first dummy pattern DP1-1 may overlap the first dummy electrode 142 of the second dummy pattern DP2-1 in the thickness direction. For example, a first dielectric receiving portion 141a may overlap the second dummy electrode 152 in the thickness direction, and the first dielectric receiving portion 142a may overlap the second dummy electrode 151 in the thickness direction. Thereby, a step difference between the capacitance formation portion Ac and the margin portions 114 and 115 may be effectively alleviated, and the stability of the multilayer electronic component 100-1 against shear stress may be further effectively improved.

Referring to FIGS. 7A and 7B, the dummy patterns DP1-2 and DP2-2 may have first dummy electrodes 141 and 142 and second dummy electrodes 151 and 152 alternately disposed in the length direction arranged in a 8×1 (length direction×width direction) form, but the present disclosure is not limited thereto. The dummy patterns DP1-2 and DP2-2 may include a plurality of first dummy electrodes 141 and 142 and second dummy electrodes 151 and 152 arranged in various forms, such as 6×1, 4×1, 2×1 (length direction×width direction), for example. However, when a gap between adjacent dummy patterns DP1-1 and DP2-1 in the length direction becomes too narrow, there may be a risk that current may flow between external electrodes of different polarities, causing short circuit defects. Accordingly, it may be preferable that the first dummy electrodes 141 and 142 and the second dummy electrodes 151 and 152 are not disposed in a central portion of the margin portions 114 and 115 in the length direction.

Here, the central portion of the margin portions 114 and 115 in the length direction may refer to a region between two dummy patterns DP1-1 and DP2-1 spaced apart from each other in the length direction. A length of the central portion of the margin portion in the length direction may be greater than a distance between the first internal electrode 121 and the fourth surface 4 in the length direction or a distance between the second internal electrode 122 and the third surface 3 in the length direction (i.e., a length of an L-margin).

When three or more dummy patterns DP1-1 and DP2-1 spaced apart from each other in the length direction are disposed in the margin portions 114 and 115, the sum of a separation distance between the dummy patterns DP1-1 and DP2-1 in the length direction may be greater than the length of the L-margin. For example, when three, four or five dummy patterns DP1-1 and DP2-1 spaced apart from each other in the length direction are disposed in the margin portions 114 and 115, the sum of the separation distances of two, three or four may be greater than the length of the L-margin.

A shape of the second dummy electrodes 151 and 152 is not particularly limited, but referring to FIG. 9, cross-sections of the dielectric receiving portions 141a and 142a and the second dummy electrodes 151 and 152 in the length direction and the width direction may be circular, respectively, and a diameter of the dielectric receiving portions 141a and 142a may be greater than a diameter of the second dummy electrodes 151 and 152. However, the present disclosure is not limited thereto, and the cross-sections of the dielectric receiving portions 141a and 142a and the second dummy electrodes 151 and 152 in the length direction and the width direction may be polygonal, respectively, or may have any shape.

In an embodiment, the cross-sections of the second dummy electrodes 151 and 152 in the length direction and the width direction may be smaller than the cross-sections of the dielectric receiving portions 141a and 142a in the length direction and the width direction, and the entire cross-sections of the second dummy electrodes 151 and 152 may overlap the cross-sections of the dielectric receiving portions 141a and 142a in the length direction and the width direction in the thickness direction.

For example, the second dummy electrodes 151 and 152 may have a shape substantially identical to the dielectric receiving portions 141a and 142a and may have a size smaller than the dielectric receiving portions 141a and 142a.

Referring to FIG. 10, the first dummy electrode 142 and the second dummy electrode 151 may not be overlapped in a direction perpendicular to the thickness direction. However, the present disclosure is not limited thereto. Due to the difference in the number of stacked internal electrode layers between the capacitance formation portion and the margin portion, during the compressing and sintering process, the margin portion may be compressed in the thickness direction compared to the capacitance formation portion. Accordingly, as shown in FIG. 11, the first dummy electrode 142 and the second dummy electrode 151 may be overlapped in a direction perpendicular to the thickness direction. That is, a portion of the second dummy electrode 151 may be disposed in the dielectric receiving portion 142a. In this case, a portion of the margin portion 114 may be inserted between the dummy conductor portion 142b of the first dummy electrode 142 and the second dummy electrode 151, thereby improving the stability of the multilayer electronic component against shear stress more effectively.

A conductive metal included in the second dummy electrodes 151 and 152 may be at least one of Ni, Cu, Pd, Ag, Au, Pt, Sn, W, Ti, and alloys thereof, and more preferably may include Ni, but the present disclosure is not limited thereto. The conductive metal included in the second dummy electrodes 151 and 152 may be the same as or different from the conductive metal included in the internal electrodes 121 and 122.

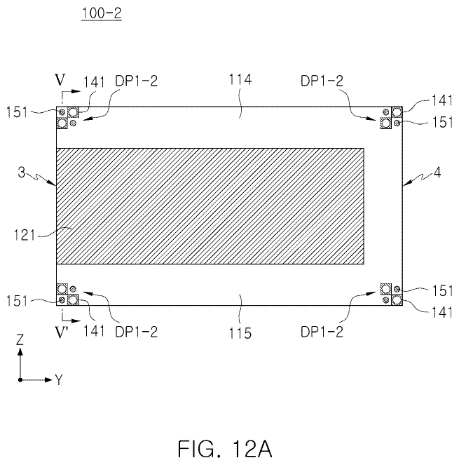

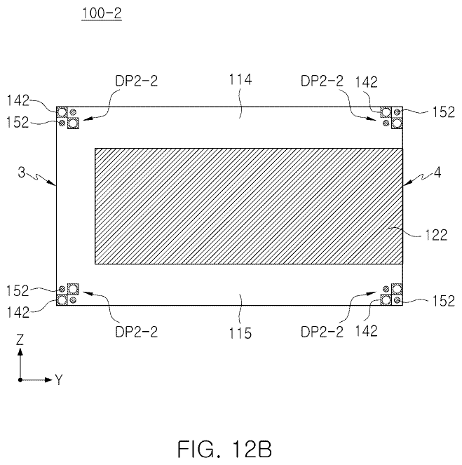

FIG. 12A is a plan view schematically illustrating a first internal electrode, a first dummy electrode, and a second dummy electrode of a multilayer electronic component according to another embodiment of the present disclosure.

FIG. 12B is a plan view schematically illustrating a second internal electrode, a first dummy electrode, and a second dummy electrode of a multilayer electronic component according to another embodiment of the present disclosure.

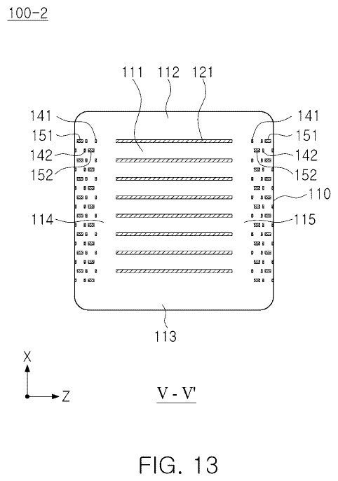

FIG. 13 is a cross-sectional view schematically illustrating a cross-section of FIG. 12A, taken along line V-V′.

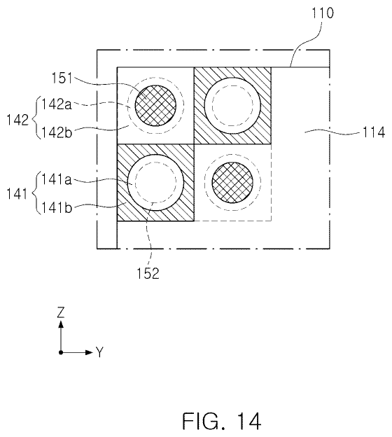

FIG. 14 is a partially enlarged view of FIG. 12A.

Hereinafter, a multilayer electronic component 100-2 according to another embodiment of the present disclosure will be described with reference to FIGS. 12A to 14. The identical/similar reference numerals are used for configurations identical/similar to those of the multilayer electronic components 100 and 100-1 described in FIGS. 1 to 11, and duplicate descriptions thereof are omitted.

The multilayer electronic component 100-2 according to an embodiment of the present disclosure may include second dummy electrodes 151 and 152 disposed in the margin portions 114 and 115 and overlapping the dielectric receiving portions 141a and 142a in the thickness direction. The multilayer electronic component 100-2 may effectively improve the withstand voltage characteristics and structural stability of the multilayer electronic component 100 by alleviating a step difference between the capacitance formation portion Ac and the margin portions 114 and 115 by including first dummy electrodes 141 and 142 and second dummy electrodes 151 and 152.

In an embodiment, the first dummy electrodes 141 and 142 and the second dummy electrodes 151 and 152 may be disposed in plural, respectively, and at least a portion of the plurality of first dummy electrodes 141 and 142 may be alternately disposed with at least a portion of the plurality of second dummy electrodes 151 and 152 in a thickness direction. For example, the first dummy electrode 141 and the second dummy electrode 152 may be alternately disposed in the thickness direction, and the first dummy electrode 142 and the second dummy electrode 151 may be alternately disposed in the thickness direction.

In an embodiment, the first dummy electrodes 141 and 142 and the second dummy electrodes 151 and 152 are disposed in plural, respectively, and a portion of the plurality of first dummy electrodes 141 and 142 may be alternately disposed with a portion of the plurality of second dummy electrodes 151 and 152 in a width direction. For example, the first dummy electrode 141 and the second dummy electrode 151 may be alternately disposed in the width direction, and the first dummy electrode 142 and the second dummy electrode 152 may be alternately disposed in the width direction.

More preferably, a portion of the plurality of first dummy electrodes 141 and 142 may be alternately disposed with a portion of the second dummy electrodes 151 and 152 in the length direction and width direction. For example, the first dummy electrode 141 and the second dummy electrode 151 may be alternately disposed in the length direction and the width direction, and the first dummy electrode 142 and the second dummy electrode 152 may be alternately disposed in the length direction and the width direction.

The multilayer electronic component 100-2 may include dummy patterns DP1-2 and DP2-2 including a plurality of first dummy electrodes 141 and 142 and second dummy electrodes 151 and 152 disposed at both ends of the margin portions 114 and 115 in the length direction, and arranged in the length direction and/or the width direction.

The multilayer electronic component 100-2 may include a first dummy pattern DP1-2 and a second dummy pattern DP2-2 alternately disposed in the thickness direction, and a first dummy electrode 141 of the first dummy pattern DP1-2 may overlap a second dummy electrode 152 of the second dummy pattern DP2-2 in the thickness direction, and a second dummy electrode 151 of the first dummy pattern DP1-2 may overlap a first dummy electrode 142 of the second dummy pattern DP2-2 in the thickness direction. For example, the first dielectric receiving portion 141a may overlap the second dummy electrode 152 in the thickness direction, and the first dielectric receiving portion 142a may overlap the second dummy electrode 151 in the thickness direction. Thereby, a step difference between the capacitance formation portion Ac and the margin portions 114 and 115 may be effectively alleviated, and the stability of the multilayer electronic component 100-2 against shear stress may be further effectively improved.

Referring to FIGS. 12A and 12B, the dummy patterns DP1-2 and DP2-2 may have first dummy electrodes 141 and 142 and second dummy electrodes 151 and 152 alternately disposed in the length direction and width direction arranged in a 2×2 (length×width) form, but the present disclosure is not limited thereto. The dummy patterns DP1-2 and DP2-2 may include a plurality of first dummy electrodes 141 and 142 and second dummy electrodes 151 and 152 arranged in various forms, such as 1×2, 2×1, 3×3, 4×4 (length direction X width direction), for example.

The dummy patterns DP1-2 and DP2-2 may be disposed in a region adjacent to a corner at which the third surface of the body meets the fifth and sixth surfaces thereof and in a region adjacent to a corner at which the fourth surface of the body meets the fifth and sixth surfaces thereof. The first dummy electrodes 141 and 142 may be exposed to an external surface of the body. For example, the first dummy electrodes 141 and 142 may be exposed to the third and/or fifth surface, to the fourth and/or fifth surface, to the third and/or sixth surface, or to the fourth and/or sixth surface. In this case, the first dummy electrodes 141 and 142 may be in contact with an external electrode, but the present disclosure is not limited thereto.

### Method for Manufacturing Multilayer Electronic Component

Hereinafter, an example of a method for forming a multilayer electronic component (100, 100-1, 100-2) is described. However, the method for manufacturing the multilayer electronic component (100, 100-1, 100-2) is not limited thereto.

First, a ceramic powder for forming a dielectric layer 111 is prepared. The ceramic powder may be a perovskite-type compound powder represented by ABO₃. The ceramic powder may include, for example, at least one of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. Methods for synthesizing the ceramic powder may include, for example, a solid-state method, a sol-gel method, a hydrothermal synthesis method, or the like, but the present disclosure is not limited thereto.

Next, the prepared ceramic powder is dried and ground, and then an organic solvent such as ethanol and a binder such as polyvinyl butyral are mixed to prepare a ceramic slurry, and the ceramic slurry is applied and dried on a carrier film to prepare a ceramic green sheet. Next, a conductive paste containing metal powder, a binder, an organic solvent, etc. is printed on a ceramic green sheet to a predetermined thickness using a screen printing method, a gravure printing method, or the like, thereby forming an internal electrode pattern and a first dummy electrode pattern. A second dummy electrode pattern may be additionally formed on the ceramic green sheet. The first and/or second dummy electrode patterns may be printed on both sides of the internal electrode pattern in a width direction. The first dummy electrode pattern may have a ring shape with a void formed in the center, and a cross section of the second dummy electrode pattern may be circular. A diameter of the second dummy electrode pattern may be smaller than a diameter of the hollow space of the first dummy electrode pattern.

After peeling off a ceramic green sheet on which an internal electrode pattern and a ceramic green sheet are printed from a carrier film, the ceramic green sheet is stacked and pressed by a predetermined number of layers to form a ceramic laminate. A ceramic green sheet on which an internal electrode pattern is not formed may be stacked to form cover portions 112 and 112 after sintering in upper and lower portions of the ceramic laminate. During the pressing process, a part of the ceramic green sheet may be inserted into the void of the first dummy electrode pattern. Alternatively, the ceramic green sheet may be inserted between the first dummy electrode pattern and the second dummy electrode pattern. Thereby, the stability of the ceramic laminate against shear stress may be improved.

Thereafter, the ceramic laminate may be cut to have a predetermined chip size, and the cut chip may be sintered to form a body 110. The sintering may be performed, for example, at a temperature within a range of 1000° C. or higher and 1400° C. or lower in a 1.0% H₂/99.0% N₂ to 3.5% H₂/96.5% N₂ (H₂O/H₂/N₂ atmosphere) for 1 to 3 hours.

Next, external electrodes 131 and 132 are formed. For example, when the base electrode layers 131a and 132a include a sintered electrode layer, the body 110 may be dipped in a conductive paste for external electrodes including a metal powder, glass frit, a binder, and an organic solvent, and then the conductive paste for external electrodes may be sintered at a temperature within a range of 500° C. to 900° C. to form a sintered electrode layer.

For example, when the base electrode layers 131a and 132a include a resin electrode layer, the body may be dipped in a conductive resin composition including a metal powder, a resin, a binder, and an organic solvent, and then cured and heat-treated at a temperature within a range of 250° C. to 550° C. to form a resin electrode layer.

In addition, an electrolytic plating method and/or electroless plating method may be additionally performed to form plating layers 131b and 132b) on the base electrode layers 131a and 132a.

As set forth above, as one of the various effects of the present disclosure, by alleviating the step difference between the capacitance formation portion and the margin portion, the withstand voltage characteristics and structural stability of the multilayer electronic component may be improved.

While the exemplary embodiments have been shown and described above, it will be apparent to those skilled in the art that modifications and variations could be made without departing from the scope of the present disclosure as defined by the appended claims.

In the present specification, the expression ‘an embodiment’ used in the present disclosure does not mean the same embodiment, and is provided to emphasize and describe different unique characteristics. However, an embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment. Terms used in this disclosure are only used to describe one embodiment, and are not intended to limit the disclosure. In this case, singular expressions include plural expressions unless the context clearly indicates otherwise.

In the present disclosure, the meaning of connected is a concept that includes not only directly connected, but also indirectly connected through an adhesive layer, or the like. In addition, the meaning of being electrically connected is a concept including both cases of “physically connected” and “not connected”. In addition, expressions such as “first”, “second”, and the like are used to distinguish one component from another component and do not limit the order and/or importance of the components. In some cases, a first component may be named a second component, and similarly, the second component may be named the first component without departing from the scope of rights.

What is claimed is:

1. A multilayer electronic component, comprising:
a body including a dielectric layer and an internal electrode alternately disposed with the dielectric layer in a thickness direction, the body having first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and
an external electrode disposed on the third and fourth surfaces,
wherein the internal electrode is disposed to be spaced apart from the fifth and sixth surfaces with a margin portion interposed therebetween,
wherein a first dummy electrode including a dielectric receiving portion is disposed in the margin portion.

2. The multilayer electronic component of claim 1, wherein the multilayer electronic component includes a second dummy electrode disposed in the margin portion and overlapping the dielectric receiving portion in the thickness direction.

3. The multilayer electronic component of claim 2, wherein the multilayer electronic component includes a plurality of each of the first and second dummy electrodes.

4. The multilayer electronic component of claim 3, wherein at least a portion of the plurality of first dummy electrodes are alternately disposed with at least a portion of the plurality of second dummy electrodes in the thickness direction.

5. The multilayer electronic component of claim 3, wherein a portion of the plurality of first dummy electrodes are alternately disposed with a portion of the plurality of second dummy electrodes in the length direction.

6. The multilayer electronic component of claim 5, wherein the plurality of first and second dummy electrodes are not disposed in a central portion of the margin portion in the length direction.

7. The multilayer electronic component of claim 3, wherein a portion of the plurality of first dummy electrodes are alternately disposed with a portion of the plurality of second dummy electrodes in the width direction.

8. The multilayer electronic component of claim 3, wherein a portion of the plurality of first dummy electrodes are alternately disposed with a portion of the plurality of second dummy electrodes in the length direction and the width direction.

9. The multilayer electronic component of claim 1, wherein the first dummy electrode includes a dummy conductor portion surrounding the dielectric receiving portion in the length direction and the width direction.

10. The multilayer electronic component of claim 1, wherein the first dummy electrode includes a ring-shaped dummy conductor portion.

11. The multilayer electronic component of claim 1, wherein the dielectric receiving portion includes at least a portion of the margin portion.

12. The multilayer electronic component of claim 2, wherein cross-sections of the dielectric receiving portion and the second dummy electrode in the length direction and the width direction are circular, respectively, and
a diameter of the dielectric receiving portion is larger than a diameter of the second dummy electrode.

13. The multilayer electronic component of claim 11, wherein a cross-section of the first dummy electrode in the length direction and the width direction are rectangular.

14. The multilayer electronic component of claim 2, wherein a cross-section of the second dummy electrode in the length direction and the width direction are smaller than a cross-section of the dielectric receiving portion in the length direction and the width direction, and
an entire cross-section of the second dummy electrode in the length direction and the width direction overlaps the cross-section of the dielectric receiving portion in the length direction and the width direction in the thickness direction.

15. The multilayer electronic component of claim 2, wherein the second dummy electrode has a shape substantially identical to the dielectric receiving portion and a size smaller than the dielectric receiving portion.

16. The multilayer electronic component of claim 1, wherein the multilayer electronic component includes a plurality of the first dummy electrode in the thickness direction, and the plurality of first dummy electrode is disposed to be misaligned with an adjacent first dummy electrode in the thickness direction, in a direction perpendicular to the thickness direction.

17. The multilayer electronic component of claim 1, wherein multilayer electronic component includes a plurality of the first dummy electrode in the thickness direction, and the plurality of first dummy electrode is disposed so as not to overlap an adjacent first dummy electrode in the thickness direction, in the thickness direction.

18. The multilayer electronic component of claim 1, wherein the multilayer electronic component includes a plurality of the first dummy electrode, and the plurality of first dummy electrode is disposed in the length direction and/or the width direction.

19. A multilayer electronic component, comprising:
a capacitance forming portion comprising:
dielectric layers extending in a length-width (L-W) plane, and
internal electrodes extending in the L-W plane with the dielectric layers interposed therebetween to be stacked in a thickness direction;
margin portion disposed on width-wise opposing surfaces of the capacitance forming portion, and extending in the thickness direction; and
first dummy electrodes disposed in the margin portion and spaced apart from the edges of the internal electrodes, and comprising:
a dielectric receiving portion including at least a portion of the margin portion, and
a dummy conductor portion.

20. The multilayer electronic component of claim 19, further including second dummy electrodes.

21. The multilayer electronic component of claim 20, wherein first dummy electrodes are alternately disposed with at least a portion of the second dummy electrodes in the thickness direction.

22. The multilayer electronic component of claim 20, wherein a diameter of the dielectric receiving portion is larger than a diameter of the second dummy electrodes.

23. The multilayer electronic component of claim 20, wherein a portion of the first dummy electrodes is alternately disposed with a portion of the second dummy electrodes in one or both of length and width directions.

24. The multilayer electronic component of claim 19, wherein the dummy conductor portion surrounds the receiving portion in length and width directions.

25. A multilayer electronic component, comprising:
a capacitance forming portion; and
margin portions disposed on opposing surfaces of the capacitance forming portion in a width direction, the margin portions comprising at least one first dummy electrode, each having a dielectric receiving portion and a dummy conductor portion surrounding the dielectric receiving portion, the dummy conductor portion being spaced apart from the capacitance forming portion.

26. The multilayer electronic component of claim 25, wherein the capacitance forming portion comprises internal electrodes disposed in a length-width plane and dielectric layers disposed between adjacent internal electrodes in a thickness direction, and wherein the at least one first dummy electrode is disposed in a length-width plane comprising an internal electrode.

27. The multilayer electronic component of claim 25, wherein a material of the dielectric receiving portion is same as that of the margin portions.

28. The multilayer electronic component of claim 25, wherein the at least one first dummy electrode is not disposed in a length-wise central portion of the margin portions.

29. The multilayer electronic component of claim 25, further including second dummy electrodes,
wherein the at least one first dummy electrode includes first dielectric receiving portions and first dummy conductors,
wherein the at least one first dummy electrode is alternately disposed with at least a portion of the second dummy electrodes in the thickness direction, and
wherein a diameter of at least one of the first dielectric receiving portions is larger than a diameter of at least one of the second dummy electrodes.
